(19) United States
(12) Patent Application Publication
(10) Pub. No.: US 2010/0259600 A1
(43) Pub. Date: Oct. 14, 2010

(54) THREE-DIMENSIONAL IMAGING APPARATUS

(76) Inventor: Koichi YOSHIKAWA, Kanagawa (JP)

Correspondence Address: FROMMER LAWRENCE & HAUG LLP, 745 FIFTH AVENUE, NEW YORK, NY, 10151, US

(21) Appl. No.: 12/754,877

(22) Filed: Apr. 6, 2010

(30) Foreign Application Priority Data
Apr. 13, 2009 (JP) P2009-097275

(51) Int. Cl. H04N 13/02

(52) U.S. Cl. 348/49; 348/E13.074

(57) ABSTRACT

A three-dimensional imaging apparatus includes: a front-side optical member formed of a non-afocal optical system, the front-side optical member forming an image of a subject; a plurality of rear-side optical members not only disposed downstream of the plane where the front-side optical member forms an image of the subject but also positioned in such a way that the optical axes of the plurality of rear-side optical members are substantially parallel to the optical axis of the front-side optical member but do not coincide therewith, the plurality of rear-side optical members refocusing a real image formed by the front-side optical member; and an imaging device that receives the light rays focused by the rear-side optical members to produce an imaged signal.

### BACKGROUND OF THE INVENTION

1. Field of the Invention

The present invention relates to a three-dimensional imaging apparatus used in a video camcorder or any other similar apparatus that captures a three-dimensional image.

2. Description of the Related Art

A camera provided with two individual imaging lenses has been used to capture a three-dimensional image. A camera of this type acquires two parallax images by using one of the two imaging lenses to capture an image for the right eye and the other imaging lens to capture an image for the left eye, as described in JP-A-2006-162990. A viewer can view a three-dimensional image when the left and right eyes of the viewer receive the respective images.

It has been desired that such three-dimensional images are used not only in entertainment but also in medical and other similar fields, and a variety of forms of three-dimensional imaging apparatus have been proposed.

FIG. 5 is a perspective view showing an example of a typical three-dimensional imaging apparatus. A three-dimensional imaging apparatus 500 includes an imaging unit 3L that captures an image for the left eye and an imaging unit 3R that captures an image for the right eye. There are a variety of methods for presenting the captured two images as a three-dimensional image.

For example, the left and right images are projected by using differently polarized light fluxes, and a viewer who views the images wears glasses with polarization filters corresponding to the differently polarized light fluxes disposed in place of left and right lenses. The images thus supplied to the left and right eyes form a three-dimensional image.

To render captured images three-dimensional, it is necessary to produce parallax between left and right images in accordance with the distance to an object to be imaged. The parallax between left and right images is determined by the distance L between the optical center 2L of a lens 1L in the imaging unit 3L, which captures an image for the left eye, and the optical center 2R of a lens 1R in the imaging unit 3R, which captures an image for the right eye.

To capture images that eventually look effectively three dimensional, it is necessary to increase L for a remote subject or reduce L for a nearby subject so that the parallax decreases.

In general, it is believed that L is preferably set at approximately 1/30 the distance to a subject to be imaged. Table 1 shows an exemplary relationship between the distance to a subject and L on the assumption described above.

TABLE 1

| Distance to subject [m] | Distance between cameras [mm] |
|---|---|
| 0.01 | 0.3 |
| 0.05 | 1.7 |
| 0.1 | 3.3 |
| 0.5 | 16.7 |
| 0.7 | 23.3 |
| 1 | 33.3 |
| 1.5 | 50.0 |
| 2 | 66.7 |
| 3 | 100.0 |
| 5 | 166.7 |
| 10 | 333.3 |
| 20 | 666.7 |
| 50 | 1666.7 |
| 100 | 3333.3 |

Some of the three-dimensional imaging apparatus described above have a zoom function. JP-A-2001-33900 discloses a technique for connecting two imaging lenses with gears and the operation rings of the two imaging lenses are rotated synchronously during a zooming operation.

JP-A-8-317424 discloses a technique for correcting deviation of the optical axes of left and right imaging optical systems that occurs in a zooming operation due to poor assembling precision in a manufacturing process by using a focus distance detector to determine and control the amount of deviation.

### SUMMARY OF THE INVENTION

On the other hand, to capture a high-quality image, in general, the housing of a camera tends to increase in size. Further, to capture a bright image, it is necessary to use a large-numerical aperture lens, which is typically a large diameter lens. A longer-focal length lens also has a larger diameter.

When a three-dimensional imaging apparatus with large-diameter lenses is used to image a nearby subject, for example, in a close-up mode, the following problem occurs in some cases: Since the diameter of each of the lenses is large, left and right lens barrels 4L, 4R or camera housings 5L and 5R shown in FIG. 5 hit against or otherwise interfere with each other. In this case, the center-to-center distance L between the left and right lenses may not be reduced in accordance with the distance to a subject.

As a result, the distance L is inevitably greater than an appropriate value. In this case, the parallax between the left and right images is unnecessarily large, resulting in an unnatural, exaggeratedly three-dimensional image.

A large L narrows the area where the fields of view of the left and right cameras overlap with each other. In this case, the two cameras may not image the same subject in a short-range imaging but may disadvantageously image different subjects.

To avoid such a situation, it is necessary to incline the two cameras inward so that the optical axes thereof are inclined. Although the area where the left and right fields of view overlap with reach other can thus be large enough, too large an angle of convergence prevents a naturally three-dimensional image from being produced.

When each of the left and right cameras has a zoom lens, another problem occurs. In particular, when video images are captured along with a zooming operation, the resultant three-dimensional image will not be natural unless the zooming operation is carried out in such a way that the angles of view of the left and right lenses synchronously change.

It is therefore necessary to accurately keep the angles of view of the left and right lenses equal to each other during a zooming operation. To this end, complicated mechanisms and processes are typically required, as described in JP-A-2001-33900 and JP-A-8-317424. This task is more difficult to achieve when the distance to a subject is shorter.

Thus, it is desirable to provide a three-dimensional imaging apparatus capable of capturing left and right images having appropriate parallax therebetween in accordance with the distance to a subject to acquire a high-quality, three-dimensional image particularly in short-range, close-up imaging.

It is further desirable to provide a three-dimensional imaging apparatus readily capable of capturing images in such a way that the left and right angles of view remain the same during zooming or other operations.

According to an embodiment of the invention, there is provided a three-dimensional imaging apparatus including a monocular, front-side optical member formed of a finite-focal-length optical system, the front-side optical member forming an image of a subject. The three-dimensional imaging apparatus further includes a plurality of rear-side optical members not only disposed downstream of the plane where the front-side optical member forms an image of the subject but also positioned in such a way that the optical axes of the plurality of rear-side optical members are parallel to the optical axis of the front-side optical member but do not coincide therewith, the plurality of rear-side optical members refocusing a real image formed by the front-side optical member. The three-dimensional imaging apparatus further includes an imaging device that receives the light rays focused by the rear-side optical members.

The configuration described above allows the light rays originating from the subject and impinging on the front-side optical member to be divided into a plurality of groups of light rays having different parallax image information and the divided groups of light rays to be guided to the respective rear-side optical members.

According to the embodiment of the invention described above, the plurality of rear-side optical members are not only disposed downstream of the plane where the monocular, front-side optical member forms an image of a subject but also positioned in such a way that the optical axes of the plurality of rear-side optical members are parallel to the optical axis of the front-side optical member but do not coincide therewith. The configuration described above allows the light rays originating from the subject and impinging on the front-side optical member to be divided into a plurality of groups of light rays having different parallax image information and the divided groups of light rays to be guided to the respective rear-side optical members. As a result, the image light produced by the monocular, front-side optical member can be used to produce an imaged signal for three-dimensional observation, whereby three-dimensional imaging can be performed in a satisfactory manner.

### BRIEF DESCRIPTION OF THE DRAWINGS

FIG. 1 describes a three-dimensional imaging apparatus according to a first embodiment of the invention;

FIG. 2 describes a three-dimensional imaging apparatus according to a second embodiment of the invention;

FIG. 3 describes a three-dimensional imaging apparatus according to a third embodiment of the invention;

FIG. 4 describes a three-dimensional imaging apparatus according to a fourth embodiment of the invention; and

FIG. 5 is a perspective view showing an example of a three-dimensional imaging apparatus of related art.

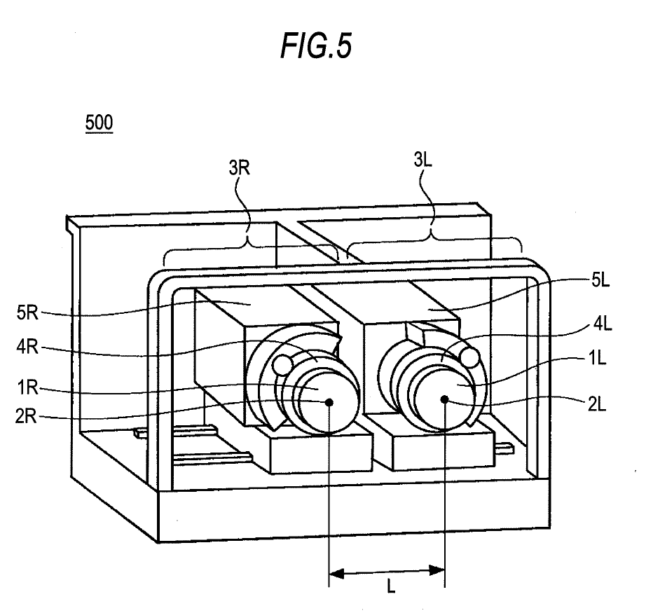

### DESCRIPTION OF THE PREFERRED EMBODIMENTS

Embodiments of the invention will be described with reference to the drawings. The description will be made in the following order.

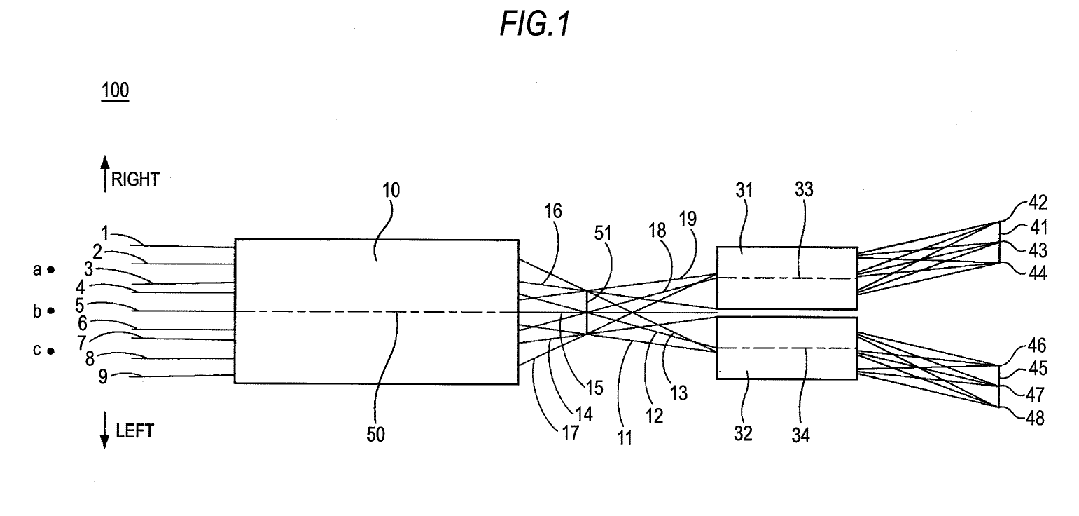

1. First Embodiment (FIG. 1)

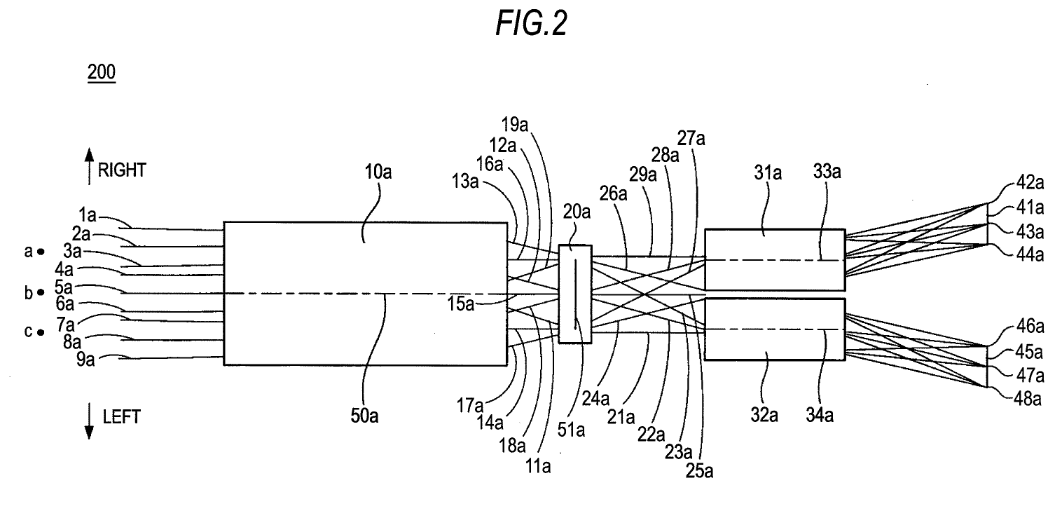

2. Second Embodiment (FIG. 2)

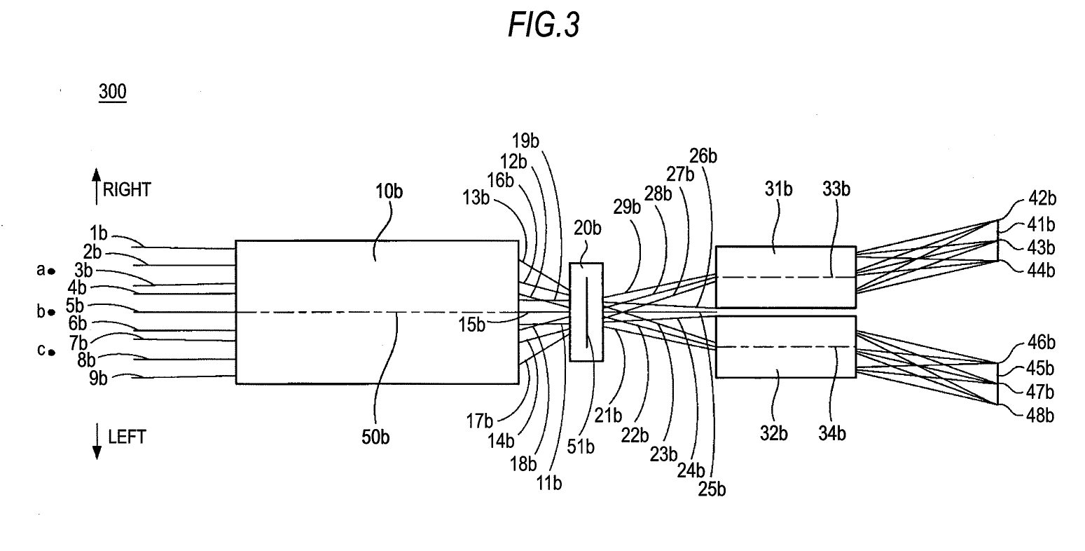

3. Third Embodiment (FIG. 3)

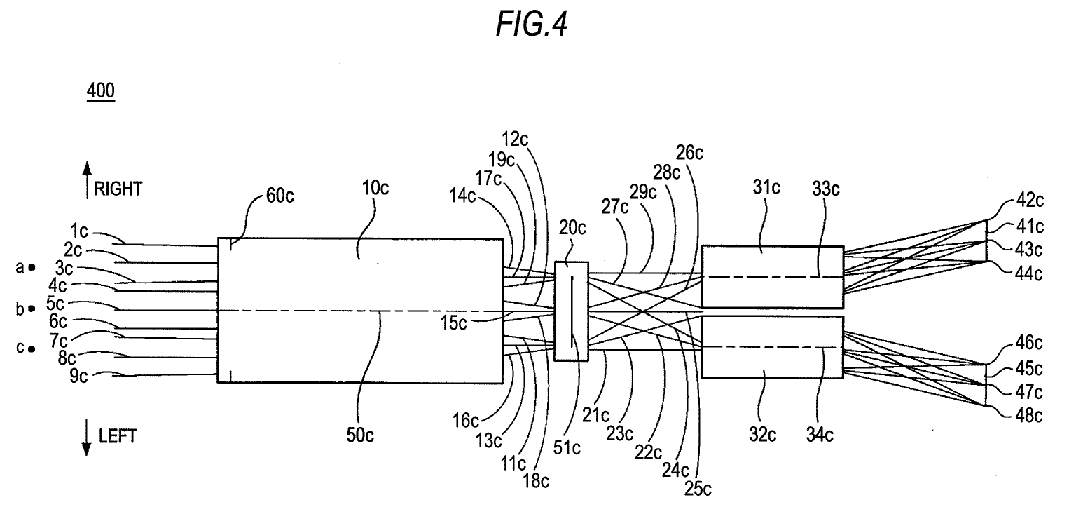

4. Fourth Embodiment (FIG. 4)

5. Variations

### 1. First Embodiment

FIG. 1 is a top view showing the configuration of a three-dimensional imaging apparatus 100 according to a first embodiment of the invention. FIG. 1 shows an optical system and imaging devices but does not show processing circuitry that processes imaged signals produced by the imaging devices. The same applies to FIG. 2 and the following figures to be described in the other embodiments.

The three-dimensional imaging apparatus 100 in the present embodiment includes a master lens 10, which is a front-side imager that collects and focuses the light from a subject. Relay lenses 31 and 32 are disposed downstream of the position where the master lens 10 forms a real image of the subject. Each of the relay lenses 31 and 32 refocuses the light collected by the master lens 10. Imaging devices 41 and 45, which receive the light from the subject, are disposed in the positions where the relay lenses 31 and 32 form images of the subject. Each of the imaging devices 41 and 45 is a CCD (Charge Coupled Device) image sensor, a CMOS (Complementary Metal Oxide Semiconductor) image sensor, or any other suitable image sensor.

Each of the imaging devices 41 and 45 receives image light, converts it into an electric imaged signal, and outputs the resultant signal. The imaging device 45 outputs an imaged signal for the right eye, and the imaging device 41 outputs an imaged signal for the left eye. A processing circuit (not shown) uses the two imaged signals to produce an image signal for three-dimensional observation.

Now, let a light ray 4 be the central light ray representing the light flux originating from a subject “a” and impinging on the master lens 10, and light rays 1 and 7 be peripheral light rays around the central light ray 4. Similarly, let a light ray 5 be the central light ray representing the light flux originating from a subject “b” located on the optical axis of the master lens 10 and impinging on the master lens 10, and light rays 2 and 8 be peripheral light rays around the central light ray 5. Further, let a light ray 6 be the central light ray representing the light flux originating from a subject “c” and impinging on the master lens 10, and light rays 3 and 9 be peripheral light rays around the central light ray 6.

The light rays 1, 4, and 7, which are light rays from the subject “a”, are refracted through the master lens 10 into light rays 11, 14, and 17 and collected on an image plane 51, which is the plane where the light rays 11, 14, and 17 are focused.

The light ray 11 is then incident on the relay lens 32 and focused into a point 48 on the imaging device 45. The light ray 17 is incident on the relay lens 31 and focused into a point 42 on the imaging device 41. The relay lenses 31 and 32 are positioned in such a way that the optical axes 33 and 34 thereof are parallel to the optical axis 50 of the field lens 10 but do not coincide therewith. The light ray 14 is guided to the gap between the relay lenses 31 and 32 and hence received by neither of the imaging devices 41, 45.

Similarly, the light rays 2, 5, and 8, which are light rays from the subject “b” located on the optical axis 50 of the master lens 10, are refracted through the master lens 10 into light rays 12, 15, and 18 and collected on the image plane 51. The light ray 5 travels along the optical axis 50 of the master lens 10. After collected, the light rays 12, 15, and 18 diverge. The light ray 12 is incident on the relay lens 32 and focused at a center point 47 of the imaging device 45.

The light ray 18 is incident on the relay lens 31 and focused at a center point 43 of the imaging device 41. In the present embodiment, the center points 43 and 47 of the imaging devices 41 and 45 are not on the optical axes 33 and 34 of the relay lenses 31 and 32 but shifted therefrom in the direction away from the optical axis 50 of the master lens 10. The light ray 15 is guided to the gap between the relay lenses 31 and 32 and hence received by neither of the imaging devices 41, 45.

The light rays 3, 6, and 9, which are light rays from the subject “c”, are similarly refracted through the master lens 10 into light rays 13, 16, and 19, collected on the image plane 51, and then diverge. The light ray 13 is incident on the relay lens 32 and focused into a point 48 on the imaging device 45. The light ray 19 is incident on the relay lens 31 and focused into a point 42 on the imaging device 41.

The light ray 16 is guided to the gap between the relay lenses 31 and 32 and hence received by neither of the imaging devices 41, 45.

In the present embodiment, the relay lenses 31 and 32 are disposed downstream of the plane where the master lens 10 forms an image, and the optical axes 33 and 34 of the relay lenses 31 and 32 are parallel to the optical axis of the master lens 10 but do not coincide therewith or are spaced apart therefrom. The configuration described above, in which the central light ray of the light flux originating from each of the subjects and impinging on the master lens 10 is guided to the gap between the relay lenses 31 and 32, prevents the central light ray from being focused on either of the imaging devices 41, 45. On the other hand, only the peripheral light rays around the central light rays, which are collected by the master lens 10 and then diverge, can be directed to the relay lens 31 or 32 and focused on the imaging device 41 or 45.

The light rays from a single subject differ from one another in terms of the angle of incidence because they are incident on the aperture of the master lens 10 in different positions. That is, light rays incident at different angles are considered to have parallax information corresponding thereto.

Therefore, in the present embodiment, for example, the light flux originating from a subject and impinging on the master lens 10 can be conceptually divided by the plane including the central light ray of the light flux and extending in the up/down direction into a light flux having parallax information for the right eye and a light flux having parallax information for the left eye. The resultant two light fluxes are then focused on the respective imaging devices.

For example, among the light rays from the subject “a” shown in FIG. 1, those on the right of the light ray 4 and in the vicinity of the light ray 1 are considered to have parallax information on the subject “a” for the right eye. On the other hand, among the light rays from the subject “a”, those on the left of the light ray 4 and in the vicinity of the light ray 7 have parallax information on the subject “a” for the left eye.

The light passing through the master lens 10 is temporarily collected and then diverges. Therefore, the light rays having parallax information for the right eye are incident on the relay lens 32 and focused on the imaging device 45, and the light rays from the subject “a” but located in the vicinity of the light ray 7 and having parallax information for the left eye are incident on the relay lens 31 and focused on the imaging device 41.

Similarly, among the light rays from the subject “b”, those on the right of the plane including the central one of the light rays and extending in the up/down direction, and among the light rays from the subject “c”, those on the right of the plane including the central one of the light rays and extending in the up/down direction, are incident on the relay lens 32 and focused on the imaging device 45.

On the other hand, among the light rays from the subject “b”, those on the left of the plane including the central one of the light rays and extending in the up/down direction, and among the light rays from the subject “c”, those on the left of the plane including the central one of the light rays and extending in the up/down direction, are incident on the relay lens 31 and focused on the imaging device 41.

The image thus formed by the imaging device 45 is used as an image for the right eye, and the image thus formed by the imaging device 41 is used as an image for the left eye. Supplying a viewer with the images for the right and left eyes allows the viewer to view a three-dimensional image.

When two lenses are used to acquire images for the right and left eye, as in related art, and a subject to be imaged is located within a short range, the lenses physically interfere with each other, inevitably resulting in a larger amount of parallax than an optimum value. In the present embodiment, however, since light rays incident on the single master lens 10 are used to form two parallax images, the problem described above can be solved. An image for three-dimensional observation can thus be produced from a subject within a short range.

The master lens 10 may be any lens that focuses light from a subject. In the present embodiment, in particular, the master lens 10 is a non-afocal focusing optical system. Using an afocal optical system causes difficulty in changing magnification by moving or translating a lens or otherwise changing the position thereof. In contrast, in the present embodiment, the master lens 10 can be readily provided with a zoom function.

In a three-dimensional imaging apparatus having two front-side lenses of related art, it is difficult to accurately synchronize the angles of view of the left and right two lenses during a zooming operation. In the present embodiment, however, since providing the master lens 10 with a zoom function allows the single lens alone to adjust magnification, keeping the angles of view equal to each other described above is not necessary.

The other problem of a two-lens system, that is, deviation of the optical axes of the left and right lenses in a zoom operation due to poor assembling precision, can be solved without any complicated configuration in the present embodiment.

### 2. Second Embodiment

FIG. 2 is a top view showing the configuration of a three-dimensional imaging apparatus 200 according to a second embodiment of the invention. The three-dimensional imaging apparatus 200 in the present embodiment includes a master lens 10a, which is a front-side imager that collects and focuses the light from a subject. The three-dimensional imaging apparatus 200 further includes a field lens 20a disposed in the position where the master lens 10a forms a real image of the subject. The field lens 20a divides the light flux collected by the imager into two groups on opposite sides of the plane including the central light ray of the light flux from the subject and extending in the up/down direction. The three-dimensional imaging apparatus 200 further includes relay lenses 31a and 32a disposed downstream of the field lens 20a. The relay lenses 31a and 32a refocus the respective divided light fluxes. The three-dimensional 200 further includes imaging devices 41a and 45a disposed on the image plane 51a where the relay lenses form images of the subject. The imaging devices 41a and 45a receive the light from the subject.

Now, let a light ray 4a be the central light ray representing the light flux originating from a subject “a” and impinging on the master lens 10a, and light rays 1a and 7a be peripheral light rays around the light ray 4a. Similarly, let a light ray 5a be the central light ray of the light flux originating from a subject “b” located on the optical axis of the master lens 10a and impinging on the master lens 10a, and light rays 2a and 8a be peripheral light rays around the light ray 5a. Further, let a light ray 6a be the central light ray of the light flux originating from a subject “c” and impinging on the master lens 10a, and light rays 3a and 9a be peripheral light rays around the light ray 6a.

The behavior of the light rays from each of the subjects will be described below. The light ray 4a from the subject “a” is refracted through the master lens 10a into a light ray 14a. The light ray 1a from the subject “a”, which is a peripheral light ray around the light ray 4a, is refracted through the master lens 10a into a light ray 11a. Similarly, the light ray 7a, which is another peripheral light ray around the light ray 4a, is refracted through the master lens 10a into a light ray 17a.

The field lens 20a, which is disposed on the image plane 51a where the light rays 11a, 14a, and 17a are focused, refracts the light ray 11a, which is a peripheral light ray from the subject “a”, into a light ray 21a.

The light ray 21a is incident on the relay lens 32a disposed downstream of the field lens 20a and focused by the relay lens 32a, for example, into a point 46a on the imaging device 45a, which receives image light rays for the right eye. That is, the relay lens 32a refocuses a real image focused by the master lens 10a on the imaging device 45a.

The relay lens 32a is disposed in such a way that the optical axis 34a thereof is substantially parallel to the optical axis 50a of the master lens 10a but does not coincide therewith. In the example shown in FIG. 2, the relay lens 32a is disposed in such a way that the optical axis 34 thereof is positioned on the left of the optical axis 50a of the master lens 10a.

On the other hand, the light ray 17a, which is another peripheral light ray from the subject “a”, is refracted through the field lens 20a into a light ray 27a and incident on the relay lens 31a. The light ray 27a is then focused, for example, into a point 42a on the imaging device 41a, which receives image light rays for the left eye.

The light ray 14a, which is the central light ray of the light flux from the subject “a”, is refracted through the field lens 20a into a light ray 24a. Since the light ray 24a reaches the gap between the relay lenses 31a and 32a, it is incident on neither of the relay lenses or received by neither of the imaging devices 41a, 45a.

As described above, among the light rays originating from the subject “a”, collected by the master lens 10a, and directed toward the image plane 51a, the field lens 20a causes the light rays on the right of the plane including the light ray 14a, which is the central light ray, and extending in the up/down direction to be incident on the relay lens 32a and the light rays on the left of the plane including the light ray 14a and extending in the up/down direction to be incident on the relay lens 31a. The field lens 20a can be, for example, a condenser lens having a high positive refracting power. The field lens 20a is disposed in the position where the master lens 10a forms an image of a subject in the present embodiment, but may be disposed in any other appropriate position where the field lens 20a can distribute light rays to the relay lenses 31a and 32a in the same manner described above.

Similarly, the light rays 2a, 5a, and 8a, which are light rays from the subject “b”, are collected by the master lens 10a and focused on the image plane 51a. For example, the light ray 5a traveling along the optical axis 50a of the master lens 10a still travels along the optical axis 50a even after it passes through the master lens 10a and becomes a light ray 15a. The light ray 2a, which is a peripheral light ray around the light ray 5a, passes through the master lens 10a into a light ray 12a. The light ray 8a, which is another peripheral light ray around the light ray 5a, passes through the master lens 10a into a light ray 18a.

The light rays originating from the subject “b” and collected by the master lens 10a are distributed by the field lens 20a disposed on the image plane 51a, which is the plane where the light rays are focused, to the relay lenses 31a and 32a disposed downstream of the field lens 20a.

That is, among the light rays from the subject “b”, the light rays on the left of the plane including the light ray 15a, which is the central light ray, and extending in the up/down direction are refracted through the field lens 20a and incident on the relay lens 31a. The light rays on the right of the plane including the light ray 15a and extending in the up/down direction are refracted through the field lens 20a and incident on the relay lens 32a.

Therefore, the light ray 18a on the left of the plane including the light ray 15a and extending in the up/down direction is guided through the field lens 20a and incident on the relay lens 31a, which focuses the light ray, for example, into the center point 43a of the imaging device 41a. The light ray 12a on the right of the plane is guided through the field lens 20a and incident on the relay lens 32a, which focuses the light ray into the central point 47a of the imaging device 45a. The light ray 15a, which is the central light ray, passes through the field lens 20a, then reaches the gap between the relay lenses 31a and 32a, and is hence not collected or focused on the imaging device 41a or 45a.

The same applies to the light rays originating from the subject “c” and impinging on the master lens 10a. The light ray 6a, which is the central light ray, passes through the master lens 10a into a light ray 16a. The light rays 3a and 9a, which are peripheral light rays around the light ray 6a, are refracted through the master lens 10a into light rays 13a and 19a, respectively.

The light rays described above originating from the subject “c” and collected by the master lens 10a onto the image plane 51a are distributed by the field lens 20a disposed on the image plane 51a to the relay lenses 31a and 32a disposed downstream thereof.

In the light flux originating from the subject “c” and collected by the master lens 10a, the light on the right of the plane including the light ray 16a, which is the central light ray, and extending in the up/down direction is guided through the field lens 20a to the relay lens 32a. The light on the left of the plane including the light ray 16a and extending in the up/down direction is guided through the field lens 20a to the relay lens 31a.

Therefore, the light ray 13a on the right of the plane including the light ray 16a and extending in the up/down direction passes through the field lens 20a into a light ray 23a and is guided to the relay lens 32a, which focuses the light ray 23a, for example, into a point 48a on the imaging device 45a for a right-eye image.

The light ray 19a on the left of the plane including the light ray 16a and extending in the up/down direction passes through the field lens 20a into a light ray 29a and is guided to the relay lens 31a, which focuses the light ray 29a, for example, into a point 44a on the imaging device 41a for a left-eye image.

The light ray 16a, which is the central light ray of the light flux from the subject “c”, is guided through the field lens 20a to the gap between the relay lenses 31a and 32a and is hence focused on neither of the imaging devices.

As described above, in the present embodiment as well, in the light flux originating from a subject and impinging on the master lens 10a, the central light ray of the light flux is focused on neither of the imaging devices but the peripheral light rays around the central light ray are focused on either of the imaging devices.

For example, the light in the vicinity of the light rays 1a, 2a, and 3a in FIG. 2 have parallax information for the right eye, and the light is temporarily collected by the master lens 10a. Each of the light rays having parallax information for the right eye corresponds to a light ray on the right of the plane including the central light ray of the collected light flux from the corresponding subject and extending in the up/down direction.

The light ray described above is guided through the field lens 20a to the relay lens 32a and focused on the imaging device 45a.

Further, among the light from the subjects, the light fluxes on the left of the plane including the respective central light rays and extending in the up/down direction, that is, the light rays in the vicinity of the light rays 7a, 8a, and 9a in FIG. 2, are considered to have parallax information on the subjects “a”, “b”, and “c” for the left eye and collected by the master lens 10a as well. Each of the light rays in question corresponds to a light ray on the left of the plane including the central light ray of the corresponding collected light flux and extending in the up/down direction.

The light rays in question are then incident on the relay lens 31a through the field lens 20a and focused on the imaging device 41a.

As described above, three-dimensional observation is achieved by supplying the image formed on the imaging device 45a, where the light having parallax information for the right eye is focused, as an image for the right eye and the image formed on the imaging device 41a as an image for the left eye.

The master lens 10a may be a detachable adapter lens that can be replaced with another lens in accordance with the situations. It is preferred in this case that the field lens 20a is also replaced with another one at the same time when the master lens is replaced.

### 3. Third Embodiment

The field lens, which divides the light rays from a subject and distributes the divided light rays to two relay lenses, can be a concave lens having a negative refracting power.

FIG. 3 is a top view of a three-dimensional imaging apparatus 300 according to a third embodiment of the invention. The three-dimensional imaging apparatus 300 according to the present embodiment includes a master lens 10b, which is a front-side imager that collects and focuses the light from a subject. The three-dimensional imaging apparatus 300 further includes a field lens 20b disposed in the position where the master lens forms a real image of the subject. The field lens 20b causes the light flux collected by the front-side imager to diverge. The three-dimensional imaging apparatus 300 further includes relay lenses 31b and 32b disposed downstream of the field lens 20b. The relay lenses 31b and 32b refocus the diverging light. The three-dimensional imaging apparatus 300 further includes imaging devices 41b and 45b disposed in the position where the relay lenses form images of the subject. The imaging devices 41b and 45b receive the light from the subject.

In this case as well, light rays 1b, 4b, and 7b from a subject “a”, light rays 2b, 5b, and 8b from a subject “b”, and light rays 3b, 6b, and 9b from a subject “c” are collected by the master lens 10b and focused on an image plane 51b. The light rays 4b, 5b, and 6b are the central light rays of the light fluxes from the respective subjects “a”, “b”, and “c”.

The light rays 1b, 4b, and 7b from the subject “a” are collected by the master lens 10b into light rays 11b, 14b, and 17b. The light ray 11b on the right of the plane including the light ray 14b, which is the central light ray, and extending in the up/down direction is a light ray having parallax information for the right eye, and refracted through the field lens 20b into a diverging light ray 21b, which is incident on the relay lens 32b.

The light ray 17b on the left of the plane including the light ray 14b and extending in the up/down direction is a light ray having parallax information for the left eye, and refracted through the field lens 20b into a diverging light ray 27b, which is incident on the relay lens 31b.

The optical axes 33b and 34b of the relay lenses 31b and 32b are parallel to the optical axis 50b of the master lens 10b and spaced apart from the optical axis 50b.

Similarly, the light rays 2b, 5b, and 8b, which are light rays from the subject “b”, are collected by the field lens 20b into light rays 12b, 15b, and 18b. The light ray 12b on the right of the plane including the light ray 15b, which is the central light ray, and extending in the up/down direction is refracted through the field lens 20b into a diverging light ray 22b, which is incident on the relay lens 32b. On the other hand, the light ray 18b on the left of the plane including the light ray 15b, which is the central light ray, and extending in the up/down direction is refracted through the field lens 20b into a diverging light ray, which is incident on the relay lens 31b.

The same applied to the light rays 3b, 6b, and 9b, which are light rays from the subject “c”. The light rays 3b, 6b, and 9b are collected by the master lens 10b into light rays 13b, 16b, and 19b. The light ray 13b, which is a light ray having parallax information for the right eye, is refracted through the field lens 20b into a diverging light ray 23b, which is incident on the relay lens 32b. The light ray 19b, which is a light ray having parallax information for the left eye, is refracted through the field lens 20b into a diverging light ray 29b, which is incident on the relay lens 31b.

In this way, the light rays 1b, 2b, and 3b, which are light rays originating from the respective subjects and having parallax information for the right eye, are incident on the relay lens 32b as the light rays 21b, 22b, and 23b and focused on the imaging device 45b.

The light rays 7b, 8b, and 9b having parallax information for the left eye are incident on the relay lens 31b as the light rays 27b, 28b, and 29b and focused on the imaging device 41b.

The light rays 4b, 5b, and 6b, which are the central light rays of the light fluxes from the respective subjects, are guided through the field lens 20b as light rays 24b, 25b, and 26b to the gap between the relay lenses 31b and 32b and are hence focused on neither of the imaging devices.

### 4. Fourth Embodiment

FIG. 4 is a top view of a three-dimensional imaging apparatus 400 according to a fourth embodiment of the invention. The three-dimensional imaging apparatus 400 according to the present embodiment includes a master lens 10c, which is a front-side imager that collects and focuses the light from a subject, and a variable-size aperture stop 60c that limits the light rays to be incident on the master lens 10c. The three-dimensional imaging apparatus 400 further includes a′field lens 20c disposed in the position where the master lens 10c forms a real image of the subject. The field lens 20c divides the collected light into two groups on opposite sides of the plane including the central light ray of the light flux from the subject and extending in the up/down direction. The three-dimensional imaging apparatus 400 further includes relay lenses 31c and 32c disposed downstream of the field lens 20c. The relay lenses 31c and 32c focus the divided light fluxes. The three-dimensional imaging apparatus 400 further includes imaging devices 41c and 45c disposed on the position where the relay lenses form images of the subject. The imaging devices 41c and 45c receive the light from the subject.

FIG. 4 showing the present embodiment differs from FIG. 1 showing the first embodiment in that the aperture stop 60c is used to reduce the size of the aperture of the stop to limit the light rays to be incident on the master lens 10c.

Now, let a light ray 3c be the central light ray of the light flux originating from a subject “a” and impinging on the master lens 10c, and light rays 1c and 6c be peripheral light rays around the light ray 3c. Further, let a light ray 5c be the central light ray of the light flux originating from a subject “b” located on the optical axis 50c of the master lens 10c and impinging on the master lens 10c, and light rays 2c and 8c be representative peripheral light rays around the light ray 5c. Similarly, let a light ray 7c be the central light ray of the light flux from a subject “c” and light rays 4c and 9c be peripheral light rays around the light ray 7c.

The central light rays 3c, 5c, and 7c of the light fluxes originating from the respective subjects “a”, “b”, and “c” and impinging on the master lens 10c are principal rays because they, although not shown, pass through a central portion of the aperture stop 60c.

Since the light rays originating from each of the subjects and directed toward the periphery of the master lens 10c are blocked by the aperture stop 60c and do not enter the master lens 10c, the light flux incident on the master lens 10c is narrower than that shown in FIG. 1.

The light rays 1c, 3c, and 6c, which are light rays from the subject “a”, are collected by the master lens 10c into light rays 11c, 13c, and 16c. The field lens 20c disposed on an image plane 51c, where the light rays 11c, 13c, and 16c are focused, guides the light rays having parallax information for the right eye to the relay lens 32c and the light rays having parallax information for the left eye to the relay lens 31c.

That is, the light ray on the left of the plane including the light ray 13c, which is the central light ray of the light flux from the subject “a”, and extending in the up/down direction is incident on the relay lens 31c. This light ray corresponds to a light ray on the left of the plane including the light ray 3c, which is the central light ray of the light flux originating from the subject “a” and impinging on the master lens 10c, and extending in the up/down direction.

FIG. 4 shows the paths of light rays when the field lens 20c is a lens having a positive refracting power. The field lens 20c may, of course, alternatively be a lens having a negative refracting power that causes light rays to diverge.

The light ray on the right of the plane including the light ray 13c and extending in the up/down direction is incident on the relay lens 32c. This light ray, among the light rays originating from the subject “a” and impinging on the master lens 10c, corresponds to a light ray on the right of the plane including the light ray 3c, which is the central light ray, and extending in the up/down direction.

That is, the light ray 11c passes through the field lens 20c into a light ray 21c and impinges on the relay lens 32c. The light ray 21c is then focused on the imaging device 45c. The light ray 16c becomes a light ray 26c, impinges on the relay lens 31c, and is focused on the imaging device 41c. The light ray 13c, which is the central light ray of the light flux from the subject “a”, passes through the field lens 20c into a light ray 23c and is guided to the gap between the relay lenses 31c and 32c. The light ray 23c is therefore focused on neither of the imaging devices.

In the present embodiment as well, the optical axes 33c and 34c of the relay lenses 31c and 32c are substantially parallel to the optical axis 50c of the master lens 10c but do not coincide therewith, as in the first embodiment shown in FIG. 1.

The centers of the imaging devices 41c and 45c are disposed in positions shifted outward from the optical axis 33c of the relay lens 31c and the optical axis 34c of the relay lens 32c, respectively.

The light rays 2c, 5c, and 8c, which are light rays from the subject “b”, are collected by the master lens 10c into light rays 12c, 15c, and 18c. The light ray 12c on the right of the plane including the light ray 15c, which is the central light ray of the light flux from the subject “b”, and extending in the up/down direction passes through the field lens 20c into a light ray 22c, is guided to the relay lens 32c, and is focused on the imaging device 45c.

The light ray 18c on the left of the plane including the light ray 15c and extending in the up/down direction passes through the field lens 20c into a light ray 28c, is guided to the relay lens 31c, and is focused on the imaging device 41c.

The light ray 15c, which is the central light ray, passes through the field lens 20c into a light ray 25c and reaches the gap between the relay lenses 31c and 32c. The light ray 25c is therefore focused on neither of the imaging devices.

Similarly, the light rays 4c, 7c, and 9c originating from the subject “c” and impinging on the master lens 10c are collected into light rays 14c, 17c, and 19c. The light ray 14c on the right of the plane including the light ray 17c, which is the central light ray of the light flux from the subject “c”, and extending in the up/down direction passes through the field lens 20c into a light ray 24c, is guided to the relay lens 32c, and is focused on the imaging device 45c.

The light ray 19c on the left of the plane including the light ray 17c and extending in the up/down direction passes through the field lens 20c into a light ray 29c, is guided to the relay lens 31c, and is focused on the imaging device 41c.

Since the light rays 3c, 5c, and 7c are principal rays as described above, the light rays 13c, 15c, 17c, 23c, 25c, and 27c, which are refracted light rays 3c, 5c, and 7c, are also principal rays.

In the three-dimensional imaging apparatus 400 of the present embodiment, a viewer can view a three-dimensional image when the left eye of the viewer receives the image acquired by the imaging device 41c and the right eye receives the image acquired by the imaging device 45c.

In the present embodiment, the light flux originating from a subject and impinging on the master lens 10c is reduced in diameter by the aperture stop 60c. That is, since the light rays that originate from the subject and reach the periphery of the aperture of the master lens 10c are blocked by the aperture stop 60c, light rays having large parallax information are focused on neither of the imaging devices. As a result, the three-dimensional imaging apparatus 400 according to the present embodiment can capture images for the right and left eyes having a smaller amount of parallax than that in the first to third embodiments shown in FIGS. 1 to 3.

Therefore, to image a subject within a short range, the amount of parallax can be reduced by reducing the size of the aperture of the stop. On the other hand, when the distance from a subject to the camera is large, the amount of parallax may be increased by increasing the size of the aperture of the stop.

When two lenses are used, as in related art, to stereoscopically image a subject the distance to which continuously changes, it is necessary to change the distance between the two lenses and the angle between the optical axes thereof in a synchronous manner.

The mechanical configuration of the camera is disadvantageously complicated accordingly.

In contrast, in the present embodiment, the amount of parallax can be instantly and readily adjusted in accordance with the distance to a subject by changing the size of the aperture of the stop.

In the present embodiment as well, a zoom function is readily provided by using a non-afocal optical system as the master lens 10c, for example, by employing a configuration in which the position of the entrance pupil or the exit pupil is shifted from the focal plane.

### 5. Variations

The above embodiments have been described with reference to a case where two imaging devices are disposed. Alternatively, a single imaging device may be used to capture images. That is, in the example shown in FIG. 1, for example, a single imaging device is disposed and configured to image a broad area that covers the range imaged by the imaging device 41 and the range imaged by the imaging device 45. An imaged signal outputted as a result of an imaging operation performed by the single imaging device is used to extract an imaged signal representing the range imaged by the imaging device 41 and an imaged signal representing the range imaged by the imaging device 45. Two image signals for three-dimensional observation are thus produced. The number of imaging devices can thus be reduced and hence the configuration of the camera can be simplified.

Further, the above embodiments have been described with reference to a case where the optical parts that form the optical path from the master lens to the imaging devices are fixed. Alternatively, part of the optical parts may be detachable. For example, a selectable master lens imaging apparatus may be achieved by employing a configuration in which the master lens is detachable.

The present application contains subject matter related to that disclosed in Japanese Priority Patent Application JP 2009-097275 filed in the Japan Patent Office on Apr. 13, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional imaging apparatus comprising:
a front-side optical member formed of a non-afocal optical system, the front-side optical member forming an image of a subject;
a plurality of rear-side optical members not only disposed downstream of the plane where the front-side optical member forms an image of the subject but also positioned in such a way that the optical axes of the plurality of rear-side optical members are substantially parallel to the optical axis of the front-side optical member but do not coincide therewith, the plurality of rear-side optical members refocusing a real image formed by the front-side optical member; and
an imaging device that receives the light rays focused by the rear-side optical members to produce an imaged signal.

2. The three-dimensional imaging apparatus according to claim 1,
further comprising a field lens disposed between the front-side optical member and the rear-side optical members,
wherein the field lens not only distributes the light flux originating from the subject and collected by the front-side optical member to the individual rear-side optical members but also guides the central light ray of the light flux from the subject to the gap between the plurality of rear-side optical members.

3. The three-dimensional imaging apparatus according to claim 2,
wherein the imaging device is provided for each of the plurality of rear-side optical members.

4. The three-dimensional imaging apparatus according to claim 2,
wherein the front-side optical member includes a zoom lens.

5. The three-dimensional imaging apparatus according to claim 2,
wherein the front-side optical member further has an aperture adjustment function of changing the area of the aperture stop through which light rays pass.

6. The three-dimensional imaging apparatus according to claim 2,
wherein the field lens is a condenser lens having a positive refracting power.

7. The three-dimensional imaging apparatus according to claim 2,
wherein the field lens is a lens having a negative refracting power.

8. A three-dimensional imaging apparatus comprising:
a front-side optical member that forms a real image of a subject in a predetermined position;
a plurality of rear-side optical members positioned in such a way that the optical axes thereof are parallel to the optical axis of the front-side optical member but do not coincide therewith, the plurality of rear-side optical members refocusing the real image; and
an imaging device that receives the light rays focused by the rear-side optical members to produce an imaged signal.
